(19) United States
(12) Patent Application Publication
(10) Pub. No.: US 2022/0366320 A1
(43) Pub. Date: Nov. 17, 2022

(54) FEDERATED LEARNING METHOD, COMPUTING DEVICE AND STORAGE MEDIUM

(71) Applicant: BEIJING BAIDU NETCOM SCIENCE TECHNOLOGY CO., LTD., Beijing (CN)

(72) Inventors: Ji LIU, Beijing (CN); Chendi ZHOU, Beijing (CN); Juncheng JIA, Beijing (CN); Dejing DOU, Beijing (CN)

(21) Appl. No.: 17/864,098

(22) Filed: Jul. 13, 2022

(30) Foreign Application Priority Data
Jul. 13, 2021 (CN) 202110792130.3

(51) Int. Cl. G06N 20/20

(52) U.S. Cl. CPC G06N 20/20

(57) ABSTRACT

A computer-implemented method is provided. The method includes: executing, for each task in a federated learning system, a first training process comprising: obtaining resource information of a plurality of terminal devices of the federated learning system; determining one or more target terminal devices corresponding to the task based on the resource information; and training a global model corresponding to the task by the target terminal devices until the global model meets a preset condition.

### CROSS REFERENCE TO RELATED APPLICATION

This application claims priority to Chinese patent application No. 202110792130.3, filed on Jul. 13, 2021, the contents of which are hereby incorporated by reference in their entirety for all purposes.

### BACKGROUND

### Technical Field

The present disclosure relates to the technical field of computers, in particular to the fields of big data and deep learning.

### Description of the Related Art

Federated learning is a new distributed learning mechanism, and utilizes distributed data and computing resources to perform collaborative training of a machine learning model. In a federated learning process, a server only needs to issue a to-be-trained global model to a terminal device, then the terminal device will use private data, namely local data, to update the model, the terminal device only needs to upload an updated model parameter to the server after completing updating, the server aggregate the model parameter uploaded by the plurality of terminal devices to obtain a new global model, and iteration is performed in this way until the global model meets preset performance or number of iterations reach preset number of iterations, and privacy disclosure caused by data sharing can be effectively avoided through a federated learning training model.

### BRIEF SUMMARY

The present disclosure provides a federated learning method, a computing device and a storage medium.

According to a first aspect of the present disclosure, a computer-implemented method is provided. The method includes: executing, for each task in a federated learning system, a first training process comprising: obtaining resource information of a plurality of terminal devices of the federated learning system; determining one or more target terminal devices corresponding to the task based on the resource information; and training a global model corresponding to the task by the target terminal devices until the global model meets a preset condition.

According to a second aspect of the present disclosure, a computing device is provided. The computing device includes: one or more processors; and a memory storing one or more programs configured to be executed by the one or more processors, the one or more programs comprising instructions for performing operations comprising: executing, for each task in a federated learning system, a first training process comprising: obtaining resource information of a plurality of terminal devices of the federated learning system; determining one or more target terminal devices corresponding to the task based on the resource information; and training a global model corresponding to the task by the target terminal devices until the global model meets a preset condition.

According to a third aspect of the present disclosure, a non-transitory computer readable storage medium is provided. The computer-readable storage medium stores one or more programs comprising instructions that, when executed by one or more processors of a computing device, cause the computing device to perform operations comprising: executing, for each task in a federated learning system, a first training process comprising: obtaining resource information of a plurality of terminal devices of the federated learning system; determining one or more target terminal devices corresponding to the task based on the resource information; and training a global model corresponding to the task by the target terminal devices until the global model meets a preset condition.

It should be understood that the content described in this part is not intended to identify the key or important features of the embodiments of the present disclosure, and is not used for limiting the scope of the present disclosure as well. Other features of the present disclosure will become easily understood through the following specification.

### BRIEF DESCRIPTION OF THE SEVERAL VIEWS OF THE DRAWINGS

The drawings are used for better understanding the present solution, and do not constitute limiting to the present disclosure. Wherein:

FIG. 1 is a flow diagram of a federated learning method provided according to some embodiments of the present disclosure.

FIG. 2 is another flow diagram of a federated learning method provided according to some embodiments of the present disclosure.

FIG. 3 is a flow diagram for training a reinforcement learning model according to some embodiments of the present disclosure.

FIG. 4 is another flow diagram for training a reinforcement learning model according to some embodiments of the present disclosure.

FIG. 5 is a schematic application diagram for applying a federated learning method provided by some embodiments of the present disclosure.

FIG. 6 is a schematic structural diagram of a federated learning apparatus provided according to some embodiments of the present disclosure.

FIG. 7 is another schematic structural diagram of a federated learning apparatus provided according to some embodiments of the present disclosure.

FIG. 8 is a schematic structural diagram for training a reinforcement learning model in a federated learning apparatus in some embodiments of the present disclosure.

FIG. 9 is another schematic structural diagram for training a reinforcement learning model in a federated learning apparatus in some embodiments of the present disclosure.

FIG. 10 is a block diagram of an electronic device for implementing a federated learning method of some embodiments of the present disclosure.

### DETAILED DESCRIPTION

The example embodiment of the present disclosure is illustrated below with reference to the accompanying drawings, including various details of the embodiment of the present disclosure for aiding understanding, and should be regarded as merely examples. Therefore, those ordinarily skilled in the art should realize that various changes and modifications may be made to the embodiments described here without departing from the scope and spirit of the present disclosure. Similarly, for clarity and simplicity, the following description omits description of a publicly known function and structure.

Study of federated learning gets more and more attention, wherein improving of a federated learning efficiency is an important aspect of federated learning study, but most of the study considers performance when model reaches convergence in a single-task case, while study related to performance of federated learning of multi tasks is less. When a federated learning system has a plurality of machine learning tasks needing to be trained, how to allocate a device resource for each task to enable models of all the tasks to reach convergence more quickly is a main problem of the study.

As for different devices, such as an edge device, resources such as a graphics processing unit (GPU) and a central processing unit (CPU) of the edge device are different, and local data required by a federated learning task owned by the edge device also has heterogeneity. Therefore, when a device required by training is selected for the federated learning task, resource conditions and data distribution of the selected device will affect a current training speed of the task and improvement of model precision.

Under a federated learning environment, most of study considers scheduling of multi-service resources, and does not consider a scheduling problem of multitask sharing device resources. Because the resources of the device are limited, it cannot be ensured that there are sufficient resources to run a plurality of tasks at the same time, therefore, when service resources in a federated environment are sufficient and the plurality of tasks share all the device resources, how to improve a converge efficiency of each task for each task scheduling device is also a problem needing to be considered.

When the federated learning system has a plurality of machine learning tasks, resources of the edge device are shared, if a training efficiency of each task wants to be optimized, it needs to consider how to allocate the device for each task more reasonably so as to complete task training more efficiently. If the plurality of tasks adopt a serial mode to be trained, that is, the next task have to wait for training completion of the current task to start to be trained, which will undoubtedly increase a waiting time of the task, and the training efficiency is extremely low. Therefore, one of an effective method for reducing the waiting time is parallelism between the tasks, that is, it needs to consider how to schedule the device for each task to enable a total task completing time be minimum on the basis of parallelism.

If only the simple multitask parallelism is considered, its efficiency is low, and the device resources are not sufficiently utilized. When the single federated learning task efficiency is optimized, all the device resources only need to provide services for this task without needing to consider how to reasonably schedule the device resources among all the tasks. For example, in a scheduling algorithm FedCS, the server will select as much devices as possible for the single task within each round of limited time, so that the tasks are converged as soon as possible. If the FedCS is directly applied to a task environment, although the total completing time of the tasks is reduced, the server still only considers the current task when selecting the device each time. In addition, it cannot consider influence of a current scheduling solution on other tasks, and it also does not consider how to schedule the device resources for each task more reasonably to reduce a convergence time to a greatest extent. Therefore, when the efficiency of multitask federated learning is optimized, scheduling the device resources reasonably and effectively is a key for affecting the total completing time.

A federated learning method provided by some embodiments of the present disclosure can be applied to systems in more general distributed scenarios, such as mobile edge computing scenarios, and Internet of Things cloud service scenarios, etc. On the premise of not disclosing user privacy, the multitask federated learning can provide more efficient and more convenient task model training for the server side.

A multitask federated learning method provided by the embodiments of the present disclosure is illustrated below in detail.

Some embodiments of the present disclosure provide a federated learning method, applied to a server in a federated learning system, the federated learning system includes the server and a plurality of terminal devices, the federated learning system is used for completing a plurality of tasks, and as shown in FIG. 1, it may include:

executing, for each task in a federated learning system, a first training process comprising:
S1, obtaining resource information of a plurality of terminal devices of the federated learning system;
S2, determining one or more target terminal devices corresponding to the task based on the resource information; and
S3, training a global model corresponding to the task by the target terminal devices until the global model meets a threshold, e.g., a preset condition.

In the embodiments of the present disclosure, the target terminal devices are determined based on the resource information of the terminal devices so as to complete the tasks, that is, devices are scheduled for the plurality of tasks in federated learning based on the resource information of the terminal devices, and the plurality of tasks effectively utilize the resources of the plurality of terminal devices, to reduce a total time for completing the plurality of tasks in federated learning.

The federated learning method provided by embodiments of the present disclosure can be applied to the server in the federated learning system, the federated learning system includes the server and the plurality of terminal devices, and the federated learning system is used for completing the plurality of tasks.

The plurality of tasks can share the plurality of terminal devices, and it may be understood that each terminal device has local data used for training the global models corresponding to the plurality of tasks.

The plurality of tasks in federated learning may include tasks such as image classification, speech recognition, and text generation, etc. The task of image classification may be understood as training a model for image classification, the task of speech recognition may be understood as training a model for speech recognition, and the task of text generation may be understood as training a model for text generation.

Referring to FIG. 1, the following steps may be executed on each task in the federated learning system:
S1, obtaining resource information of a plurality of terminal devices of the federated learning system;
S2, determining one or more target terminal devices corresponding to the task based on the resource information.

As for each terminal device, the resource information of the terminal device may include at least one of the following information: internal storage, CPU information, GPU information, local data size, etc.

The server may send a resource information request to all the terminal devices, and the terminal devices return their own resource information to the server after receiving the resource information request sent by the server.

In some embodiments, the server may firstly judge whether the terminal device is available, such as not occupied by other services, and send a resource information request to the terminal device if the terminal device is available.

The server may utilize the resource information of the plurality of terminal devices to schedule each terminal device to each task respectively, that is, the corresponding terminal devices are determined for each task respectively.

The server may firstly obtain the resource information of all the terminal devices at one time. In a process of determining target resource devices for each task by utilizing the resource information, the resource information of the terminal devices may be called again by different threads or service programs to determine the target terminal devices for each task.

In some embodiments, the server firstly allocate the threads or the service programs for each task, and the threads or the service programs corresponding to each task send the resource information requests to the terminal devices. After the terminal devices receive the resource information requests, their own resource information may be returned to each thread or service program respectively, and the threads or the service programs corresponding to each task may determine the target terminal devices corresponding to the task by utilizing the obtained resource information of the terminal devices again.

S3, training a global model corresponding to the task by the target terminal devices until the global model meets a preset condition.

The server issues the global model corresponding to the task to the target terminal devices corresponding to the task, and each target terminal device train the global model to obtain model parameters, and upload the obtained model parameters to the server respectively. The server receives the model parameters returned by each target terminal device; aggregates the model parameters returned by all the target terminal devices to obtain updated global model; then judges whether the updated global model meets the threshold, e.g., the preset condition, if meeting the preset condition, iteration is ended, and the task is completed; and if not meeting the preset condition, the updated global model is continued to be issued to the target terminal devices, and each target terminal device continues to train the updated global model until the updated global model meets the preset condition. The preset condition may be preset performance, for example, may be that a loss function reaches convergence, loss function precision reaches a preset precision value, such as 0.9, etc. The preset condition needing to be met by the global models corresponding to the different tasks may be different.

In some embodiments, the tasks can be completed by multiple iteration processes, that is, the target terminal devices perform multiple training and upload the model parameters obtained by training to the server, and the server aggregate the model parameters of the plurality of target terminal devices, so that the global models corresponding to the tasks can meet the preset condition.

In some example embodiments, resources and states of the terminal devices are dynamically changed. For example, the terminal devices are idle or available at the current moment, but after a period of time, it may not be available. Or, the resources of the terminal devices are all idle at the current moment, but after a period of time, it is partially occupied, etc. Therefore, in a process of completing the tasks, each iteration needs to re-obtain resource information of the current terminal device, so as to re-determine the target terminal device used for training the global models corresponding to the tasks.

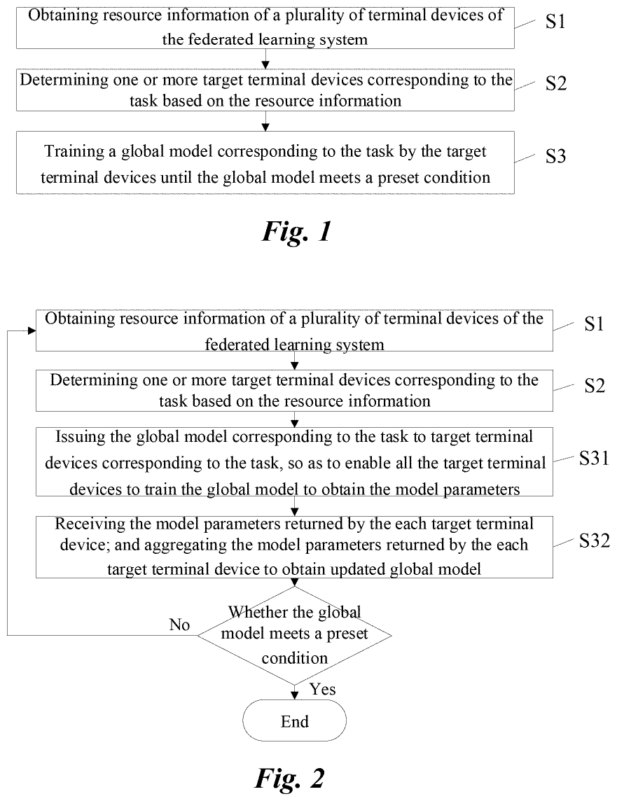

As shown in FIG. 2, the global model corresponding to the task is trained by the target terminal devices until the global model meets the preset condition, may include:
S31, issuing the global model corresponding to the task to target terminal devices corresponding to the task, so as to enable all the target terminal devices to train the global model to obtain the model parameters.
S32, receiving the model parameters returned by the each target terminal device; and aggregating the model parameters returned by the each target terminal device to obtain updated global model.

In response to the global model does not meet the preset condition, returning S1 to continue to execute S1, S2, S31 and S32 until the global model meets the preset condition.

In some embodiments, the following steps are executed respectively on each task in the federated learning system:
S1, the resource information of the plurality of terminal devices is obtained.
S2, the target terminal devices corresponding to the task are determined by utilizing the resource information.

The global model corresponding to the task is trained by the target terminal devices until the global model meets the preset condition.

S31, the global model corresponding to the task is issued to the target terminal devices corresponding to the task, so as to enable all the target terminal devices to train the global model to obtain the model parameters.

S32, the model parameters returned by all the target terminal devices are received; the model parameters returned by all the target terminal devices are aggregated to obtain the updated global model; and in response to the condition that the global model does not meet the preset condition, S1 is returned to continue to execute S1, S2, S31 and S32 until the global model meets the preset condition.

In this way, dynamic change of the resources and the states of the terminal devices may be considered, in each iteration process, the target terminal devices need to be re-determined based on the resource information of the terminal devices again, the global models are trained through the re-determined target terminal devices in each iteration process, in this way, the using condition and the like of the terminal devices can be sufficiently considered, the resource information can be utilized more reasonably, and the efficiency of model training is improved, thereby reducing the completing time of the tasks. Furthermore, all the tasks run in parallel without waiting for each other, and because the training efficiency of each task may be different, the waiting time among the tasks may be reduced by parallel running of all the tasks, thereby improving the efficiency of task training.

In some example embodiments, while the global model corresponding to the task is issued to the target terminal devices corresponding to the task, the number of iterations is issued to all the target terminal devices, so that the global model be iterated for the number of iterations during the process of training the global model by all the target terminal devices.

Wherein, the number of iterations is determined by the server based on the resource information of the terminal devices.

After the terminal devices receive the global models and the number of iterations, the global models are trained by utilizing the local data, and in the training process, training is ended after the global model be iterated for the number of iterations, so as to obtain the model parameters.

Because the resources and local data distribution of the different terminal devices are different, the server assigns locally updated number of iterations for a selected device, namely the target terminal devices, according to the resource information of the terminal devices, to enable the global models to be converged more quickly, so that the time for completing the tasks can be reduced. In some embodiments, the server may determine the number of iterations for the different terminal devices according to a computing capability of the terminal devices.

In some example embodiments, the determining the target terminal devices corresponding to the task by utilizing the resource information, may include:
the resource information is input into a pre-trained reinforcement learning model, and the target terminal devices corresponding to the task are obtained by the reinforcement learning model.

Wherein, the reinforcement learning model is obtained by taking a sample terminal device set capable of being used by a plurality of sample tasks, resource information of all sample terminal devices and characteristic information of the sample tasks as an environmental state and learning based on a reward function, and the reward function is determined based on the time spent by the sample terminal devices in completing the sample tasks and distribution of data required by completing the sample tasks in the sample terminal devices.

In some embodiments, the reinforcement learning model may directly output the target terminal devices corresponding to each task.

In some embodiments, the reinforcement learning model may output probabilities that each task correspond to the terminal devices. For each task, the terminal devices may be sorted according to the probability that this task corresponds to each terminal device, for example, may be sorted according to a sequence from high to low or from low to high. If sorting is performed according to the sequence from high to low, a preset number of terminal devices ranked ahead is selected to serve as the target terminal device corresponding to the task. If sorting is performed according to the sequence from low to high, a preset number of terminal devices ranked behind is selected as the target terminal device corresponding to the task.

In this way, the target terminal devices may be obtained based on the pre-trained reinforcement learning model, thereby reducing the time for determining the target terminal devices. The reinforcement learning model is obtained by taking the sample terminal device set capable of being used by the plurality of sample tasks, the resource information of all the sample terminal devices and the characteristic information of the sample tasks as the environmental state and learning based on the reward function, and the reward function is determined based on the time spent by the sample terminal devices in completing the sample tasks and distribution of data required by completing the sample tasks in the sample terminal devices, so that a matching degree of the determined target terminal devices and the tasks can be improved, the terminal devices are scheduled for all the tasks more reasonably, thus all the tasks sufficiently utilize the device resources, and the total time for completing all the tasks is reduced.

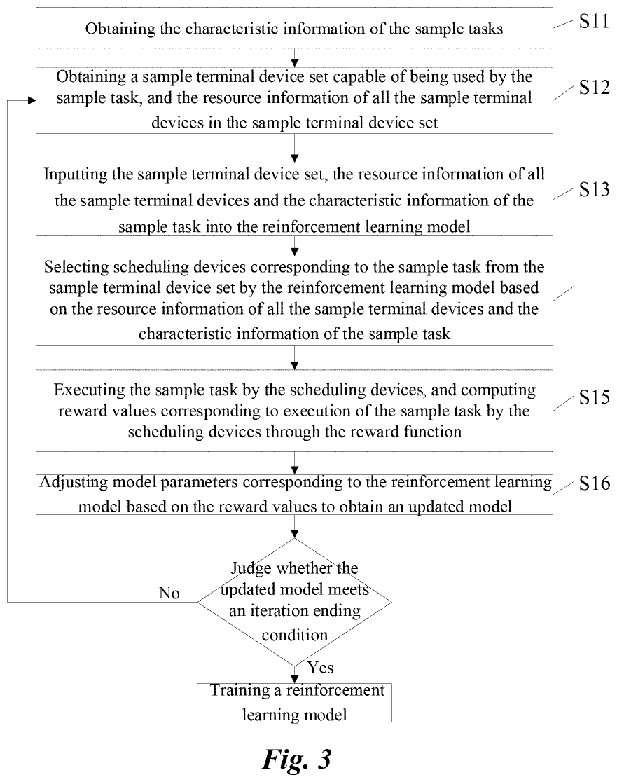

In some embodiments, the process of training to obtain the reinforcement learning model, as shown in FIG. 3, may include:

S11, the characteristic information of the sample tasks is obtained.

The characteristic information may be a type, a size and the like of the data required by completing the sample tasks.

S12, a sample terminal device set capable of being used by the sample tasks, and the resource information of all the sample terminal devices in the sample terminal device set are obtained.

S13, the sample terminal device set, the resource information of all the sample terminal devices and the characteristic information of the sample tasks are input into the reinforcement learning model.

The model may be a deep learning network, such as a long short-term memory (LSTM) network.

S14, scheduling devices corresponding to the sample tasks is selected from the sample terminal device set by the model based on the resource information of all the sample terminal devices and the characteristic information of the sample tasks.

Probabilities that the sample tasks correspond to all the sample terminal devices respectively are obtained through the model based on the resource information of all the sample terminal devices and the characteristic information of the sample tasks; all the sample terminal devices are sorted according to the probability; and a preset number of sample terminal devices is selected as the scheduling devices corresponding to the sample tasks based on a sorting result.

The terminal devices may be sorted according to the sequence of the probability from high to low, or, may also be sorted according to the sequence of the probability from low to high.

If the sample terminal devices are sorted according to the sequence of the probability from high to low, the obtained sorting result is the plurality of sample terminal devices sorted according to the sequence of the probability from high to low, and thus a preset number of sample terminal devices ranked ahead may be selected as the scheduling devices corresponding to the sample tasks.

If the sample terminal devices are sorted according to the sequence of the probability from low to high, the obtained sorting result is the plurality of sample terminal devices sorted according to the sequence of the probability from low to high, and thus a preset number of sample terminal devices ranked behind may be selected as the scheduling devices corresponding to the sample tasks.

Wherein, the preset number may be determined according to an actual demand or an empirical value, for example, ten, five, etc.

In this way, the probabilities that the sample tasks correspond to all the sample terminal devices respectively may be obtained through the model; and the sample terminal devices are selected according to the probabilities to serve as the scheduling devices corresponding to the sample tasks. The probabilities are the model based on the environmental state, namely the characteristic information of the tasks and resource new information of the terminal devices, that is, in the process of training the model, the characteristic information of the tasks and resource new information of the terminal devices are considered, in this way, the devices may be scheduled for the tasks more reasonably, and a training rate is improved. The model obtained by training can determine the target terminal devices for the tasks more accurately.

S15, the sample tasks are executed by the scheduling devices, and reward values corresponding to execution of the sample tasks by the scheduling devices is computed through the reward function.

The reward function may be determined based on the time spent by the scheduling devices in training the global models.

In some embodiments, the reward function is:

$$r = - ( {max}_{k ∈ {s}_{m}} \{ {t}_{k}^{c m} + {t}_{k}^{cp} \} + λ g ( {s}_{m} ) ) ,$$

wherein, tₖ^{cm} represents a computing time and tₖ^{cp} represents a communication time, λ represents a weight, sₘ represents a device set, namely the selected scheduling device, and g(sₘ) represents fluctuation information of data that the scheduling devices participate in training.

S16, model parameters corresponding to the model are adjusted based on the reward values to obtain an updated model; and

S12 is returned under the condition that the updated model does not meet an iteration ending condition, the above model is replaced with the updated model, and S12 to S16 are repeatedly executed until the updated model meets the iteration ending condition to obtain a trained reinforcement learning model.

The reward values are computed by utilizing the reward function, and the model is trained by utilizing reinforcement learning. For simple understanding, the scheduling devices are constantly selected from the sample terminal device set through the model based on the environmental state, the selected scheduling device is computed to compute the reward values, the model parameters are adjusted based on the reward values, in this way, the model is optimized constantly, the higher reward value is obtained constantly, it may also be understood that the higher reward is obtained until the model meets the iteration ending condition, for example, the reward values are converged or the number of iterations reach a preset threshold value, etc.

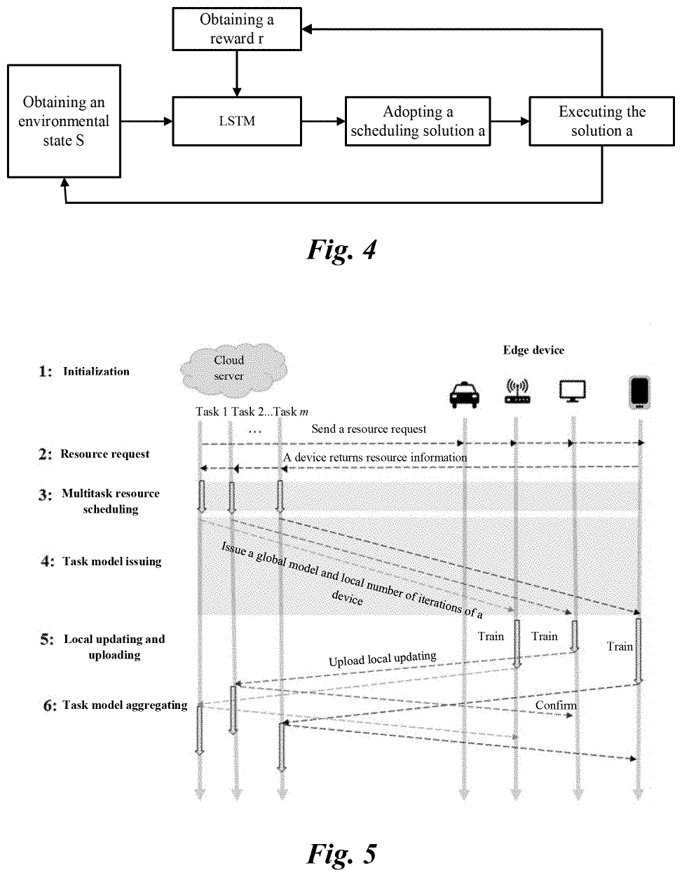

As shown in FIG. 4, the resource information of all the sample terminal devices and the characteristic information of the sample tasks are taken as the environmental state S to be input into the model, for example, may be the LSTM, then a scheduling solution is determined according to the LSTM, the scheduling solution a is adopted, and the scheduling solution may be understood as the plurality of scheduling devices. Then the scheduling solution a is executed, the reward values r corresponding to execution of the scheduling solution a are computed, then r is utilized to adjust the model parameters of the LSTM, the environmental state is re-obtained, the scheduling solution is re-selected based on the LSTM after parameter adjusting, which may also be understood as the updated model, iteration in this way, so that the reward values are increased constantly until the updated model meets the iteration ending condition. Wherein, the probabilities of the tasks on each available terminal device are obtained through the LSTM based on the environmental state. In some embodiments, the selecting the scheduling solution by the LSTM based on the environmental state may be that the LSTM determines the probabilities that the tasks correspond to the sample terminal devices based on the environmental state, then performs sorting according to the probabilities, and selects a preset number of sample terminal devices with the large probability is selected as the scheduling solution a. All the sample terminal devices may be sorted according to the sequence from high to low or from low to high, correspondingly, a preset number of sample terminal devices ranked ahead or ranked behind can be selected.

In some embodiments, model features of all the tasks of federated learning, an available device of a current task m in an environment, a task serial number m, a size of task training data and the like are served as the environmental state to be input into the LSTM, then the probability of the current task on each available device is obtained, and finally, a part of devices with the largest probability is selected to serve as a scheduling solution sₘ of the current task. Then the environmental state is updated, a reward r of the selected scheduling solution is updated according to the above reward function, then r is fed back to the LSTM network for learning, so that the higher reward is obtained next time, and the above processes are repeated all the time until the iteration is ended.

In some example embodiments, a pre-trained scheduling model may be used for initializing a neural network LSTM of an action-value function Q. Then, whether it is a training mode currently is judged, if it is the training mode, it may refer to the process shown in FIG. 4, and training is performed through the steps of the embodiment in FIG. 3 to obtain the reinforcement learning model; and if it is not the training mode, the trained reinforcement learning model may be directly called to determine the probabilities of all the terminal devices corresponding to the tasks, and then the target terminal devices corresponding to the tasks may be determined based on the probabilities.

In some embodiments, it is assumed that a federated learning environment is composed of one server and K terminal devices, wherein a device index is κ={1,2, . . . , K}. They commonly participate in model training of M different tasks, wherein an index of the tasks is m ={1,2, . . . , M}. Each terminal device has a local data set of M tasks, wherein a local data set of mth task on the device k is represented as [symbol] ₖ^{m}={x_{k,d}^{m}∈ [symbol] ^{S}^{ₘ}, y_{k,d}^{m}∈ [symbol] }_{d=1}^{D}^{ₖ}^{m}, Dₖ^{m}= [symbol] ₖ^{m}| is the sample number of data, x_{k,d}^{m} is dth sₘ-dimension input data vector of the mth task on the terminal device k, and y_{k,d}^{m} is a label of x_{k,d}^{m}. Therefore, the overall data set of the task m may be represented as [symbol] ^{m}=∪_{k∈K} [symbol] ₖ^{m}, and its sample number is D^{m}=Σ_{k∈K}Dₖ^{m}.

Each terminal device has a data set of all the tasks, while multitask federated learning is to learn the respective model parameter wₘ from the corresponding data set through the loss functions of the different tasks. A global learning problem of multitask federated learning may be expressed through the following formula:

$${min}_{W} {\sum }_{m = 1}^{M} {\sum }_{k = 1}^{K} \frac{{D}_{k}^{m}}{{D}^{m}} {F}_{k}^{m} ( {w}^{m} ) ,$$

Wherein,

$${F}_{k}^{m} ( {w}^{m} ) = \frac{1}{{D}_{k}^{m}} {\sum }_{d ∈ {D}_{k}^{m}} {f}^{m} ( {w}^{m} ; {x}_{k , d}^{m} , {y}_{k , d}^{m} ) ,$$

W:≡{ω¹, ω², . . . , ω^{m}} are a set of model weights of all the tasks, may represent that W is defined to include the set of the model weights of all the tasks, and f^{m} (ω^{m}; x_{k,d}^{m},y_{k,d}^{m}) is a model loss of input-output data of the mth task for {x_{k,d}^{m}, y_{k,d}^{m}} on the model parameter ω^{m}.

After the terminal devices receive the global models, the time spent by the terminal devices in completing a round of global training is mainly determined by the computing time t_{k,m}^{cp} and the communication time t_{k,m}^{cm}. As for each task, the time required by each round of global training is determined by the selected terminal device with the lowest speed. It is assumed that communication of the terminal device and the server is parallel, therefore, the total time required for one round of global training is as follows:

$${t}_{m}^{round} ( {s}_{m} ) \geq {max}_{k ∈ {s}_{m}} \{ {t}_{k , m}^{cm} + {t}_{k , m}^{cp} \} ,$$

In some embodiments, the efficiency of multitask learning is improved. For example, in a case that the device resources are limited, the overall training efficiency of all the tasks are mainly improved by optimizing utilization of the device resources among the tasks, therefore, the efficiency optimizing problem of multitask is as follows:

$${min}_{S} \{ {max}_{{s}_{m} ⊂ S} {\sum }_{r = 1}^{Rm} {max}_{k ∈ {s}_{m}} \{ {t}_{k , m}^{cm} + {t}_{k , m}^{cp} \} \} \\ s . t . {s}_{m} ⊂ 𝒦 , ∀ m ∈ \{ 1 , 2 , … , M \} \\ S = \{ {s}_{1} , {s}_{2} , … , {s}_{M} \} , \\ \frac{1}{{β}_{m}^{0} {R}_{m} + {β}_{m}^{1}} + {β}_{m}^{2} \leq {l}_{m} .$$

Wherein, βₘ represents a parameter of a convergence curve of the task m, lₘ is an expected loss value or a loss value reaching convergence of the task m, and Rₘ represents the round number required for achieving the expected loss lₘ.

As for the different tasks, the size of the local data and complexity of the global models on the same terminal device are different, therefore, times required by the same terminal device for completing updating of the different tasks are also different. In order to describe randomness of the time required for partial model updating, it is assumed that the time required by the terminal device for completing updating follows displacement exponential distribution:

$$P [ {t}_{k , m}^{cp} < t ] = \{ \begin{matrix}1 - {e}^{- \frac{{μ}_{k}}{{τ}_{m} {D}_{k}^{m}} ( t - {τ}_{m} {a}_{k} {D}_{k}^{m} )} , & t \geq {τ}_{m} {a}_{k} {D}_{k}^{m} \\ 0 , & otherwise\end{matrix}$$

Wherein, parameters αₖ>0 and μₖ>0 are a maximum value and a fluctuating value of a computing capability of the terminal device k. Due to the strong computing capability of the server and the low model complexity of the task, the computing time for the server to perform model aggregation can be ignored, that is, the time spent by the server in aggregating a plurality of model parameters after receiving the model parameters returned by the plurality of terminal devices can be ignored.

The multitask federated learning solves the efficiency problem of multitask training, that is, the efficiency optimization problem of the above multitask. For example, some embodiments of the present disclosure provide a device resource scheduling algorithm based on deep reinforcement learning, which is described below in detail.

After receiving the resource information of the idle terminal device, the server will start the resource scheduling algorithm, and schedule the device required by the current task according to the received resource information of the terminal device. In addition, the number of training rounds for each task does not need to be consistent, and there is no need to wait for each other among the tasks. In general, the convergence precision of the global models is given, as shown in the above formula

$$\frac{1}{{β}_{m}^{0} {R}_{m} + {β}_{m}^{1}} + {β}_{m}^{2} \leq {l}_{m} . ,$$

the number of training rounds required for convergence is also roughly determined.

In some application scenarios, for example, when the resources and states of all the terminal devices remain unchanged, the server may schedule the terminal devices required to complete all rounds of training for each task at one time according to the resource information of all the terminal devices. However, in some applications, such as an edge computing environment, resources and states of edge devices change. For example, the terminal device may be currently idle and available, but after a period of time, the device may be busy and unavailable or a part of resources may be occupied. Therefore, it is unrealistic to complete all device scheduling at one time, and some embodiments of the present disclosure adopts the idea of a greedy algorithm to obtain an approximate solution. The server schedules the target terminal device required by the current round for the to-be-trained task according to the current device information of all the available terminal devices, and ensures that at a current time node, the training time required for all the tasks is the shortest. That is, each task requires the server to schedule the terminal devices for it in each round of training.

In the terminal device scheduling process, the fairness of terminal device participation and the balance of data distribution participating in training are key factors affecting the convergence speed. If terminal devices with faster training are excessively selected, although this can speed up the training speed of each round, it will make training of the global models concentrated on a small part of terminal devices, which will eventually lead to a decrease in the convergence precision of the task. However, the ultimate objective of some embodiments of the present disclosure is to make all the tasks converge as soon as possible, that is, the total time for completing all the tasks is minimum, while ensuring the accuracy of the model. Therefore, terminal device scheduling is performed on the premise of ensuring the fairness of device participation as much as possible. First, in order to ensure the fairness of terminal device participation as much as possible, to prevent some terminal devices from participating in training excessively and to avoid selecting faster devices in the scheduling process, a hyperparameter Nm is introduced for each task. For any task, the participation frequency of the same device does not exceed Nm, which will improve the convergence speed of each task under the premise of ensuring the task precision.

For the balance of the data participating in training, data balance is taken as part of the optimization objective of the scheduling algorithm. At the same time, after adopting the greedy algorithm, the optimization problem of the resource scheduling algorithm needs to be rewritten. It is assumed that the device set scheduled by the server for the current task j in the rⱼth round of training is sⱼ. While all local data required for the training of the task j are totally divided into Lⱼ classes, and there is a set [symbol] with a size Lⱼ, wherein [symbol] ᵢ[l]=0, l={0,1, . . . , Lⱼ}. The data of all the devices participating in the training before the rⱼ+1 round are counted by category, and results are put into the set [symbol] ᵢ. Therefore, a fluctuation degree of all currently data participating in training in categories can be measured according to the following formula:

$$g ( {s}_{j} ) = \frac{1}{{L}_{j}} {\sum }_{l = 0}^{{L}_{j}} {( Q [ l ] - \frac{1}{{L}_{j}} {\sum }_{l = 0}^{{L}_{j}} Q [ l ] )}^{2}$$

The more balanced the data participating in model training, the faster and more stable the model will converge. Therefore, the problem solved by the scheduling algorithm when the task j schedules the device in the rj round can be expressed as:

$${min}_{S} \{ {\sum }_{{K}_{m} ⊂ S} {max}_{k ∈ {s}_{m}} \{ {t}_{k , m}^{cm} + {t}_{k , m}^{cp} \} + λ g ( sj ) \} \\ s . t . {s}_{m} ⊂ 𝒦 , ∀ m ∈ \{ 1 , 2 , … , M \} , \\ {s}_{j} ⊂ S , S = \{ {s}_{1} , {s}_{2} , … , {s}_{M} \}$$

Compared with a multi-objective optimization problem in the above efficiency optimization problem of the multitask, this optimization objective is easier to solve. However, this optimization objective is still a difficult combinatorial optimization problem to solve. Due to the huge scale of possible resource scheduling solutions, brute force of searching for the optimal scheduling solution will lead to a “combinatorial explosion”, and the time complexity O(M^{|κ|}) of the search is too high to be completed. Therefore, some embodiments of the present disclosure provides a scheduling algorithm based on reinforcement learning to solve the optimal scheduling solution. The reward 25 given by each action taken by a deep reinforcement learning scheduling strategy is expressed by the following formula:

$$r = - ( {max}_{k ∈ {s}_{m}} \{ {t}_{k}^{c m} + {t}_{k}^{c p} \} + λ g ( {s}_{m} ) )$$

In this scheduling strategy, LSTM and reinforcement learning are adopted to actively let the algorithm learn device scheduling autonomously. This algorithm can realize a learning process and a scheduling process of the deep reinforcement learning scheduling solution, and can select the scheduling solution for the current task according to the features of all the tasks and training parameters of the current task, and can also continue to train a scheduling network after scheduling is ended to make the scheduling network more wise.

After the reinforcement learning model is obtained by training, the reinforcement learning model may be utilized to schedule the device, that is, to determine the target terminal devices for the tasks in the federated learning system used for realizing the multitask.

In the process of task execution by federated learning, the reinforcement learning model may be called to determine the target terminal devices for the tasks. Specifically, for each task, in each iteration process, the reinforcement learning model may be called to determine the corresponding target terminal device for this iteration, and then the corresponding target terminal device is used in this iteration process to train the global model corresponding to the task. One iteration process refers to a process that the server issues the global models to the selected terminal devices, and all the selected terminal devices utilize the local data to train the global models to obtain the model, and upload the model parameters to the server, and the server aggregates all the model parameters to obtain the new global model.

Referring to FIG. 5, at a server side, the scheduling of multitask device resources and the distribution and aggregation of task models; at a device side, performing the local updating on local number of iterations assigned for the different devices according to the computing capability of the devices, specifically includes the following steps:

Step A1, the server first randomly creates an initial model for each task or pre-trains it by using public data.

That is, the global models corresponding to all the tasks are initialized.

Step A2, the server creates a service program for each task, so that all the tasks in the federated learning environment are executed in parallel, and after creation is completed, each task may send a resource information request to all devices.

The service programs corresponding to all the tasks may also first judge whether the terminal devices are idle, and if the terminal devices are idle, the resource information request is sent to the terminal devices to obtain resource information of the idle resource device.

Step A3, the terminal device receive the resource requests sent from the different tasks and return their own device resource information to the corresponding tasks. The resource information may include internal storage, CPU information, GPU information, a local data size, etc.

Wherein, the server may be a cloud server, and the terminal devices may be edge devices in an edge application environment.

Step A4, after receiving the resource information of the different devices, the service programs of the tasks schedule the devices required for the current round of training for the current task according to the scheduling strategy of the server.

In some embodiments, the service programs corresponding to the service may call the above trained reinforcement learning model, the probabilities that all the tasks correspond to the terminal devices respectively may be output through the reinforcement learning model. For all the tasks, all the terminal devices may be sorted according to the probabilities that this task corresponds to all the terminal devices, for example, may be sorted according to a sequence from high to low or from low to high. If sorting is performed according to the sequence from high to low, a preset number of terminal devices ranked ahead is selected as the target terminal device corresponding to the task. If sorting is performed according to the sequence from low to high, a preset number of terminal devices ranked behind is selected as the target terminal device corresponding to the task.

Step A5, the service program in the server distributes the global model of the current task and the locally updated number of iterations of the different devices to the devices selected in step A4, that is, the current terminal devices.

Step A6, the selected devices use the local data to update the global model of the current task downloaded from the server, and upload the obtained model parameters to the server after the training is completed.

Step A7, after receiving the updates of all the devices selected for the corresponding task, the server averages the updated model parameters to obtain the new global model of the task.

Step A8, all steps except for initialization are iterated until the global models of all the tasks achieve their desired performance.

In the multitask resource scheduling step, the server runs the device scheduling algorithm based on deep reinforcement learning according to all the obtained device resource information, that is, the trained reinforcement learning model is called to automatically generate an efficient scheduling solution for the current task to complete the current round of global training, wherein the number of the devices included in the scheduling solution of each round is not fixed, but is determined by the scheduling algorithm through self-learning. Then, the server sends the latest global model of the current task and the local number of iterations required by the different devices to update the model to the devices selected in step A4, and the selected devices use the local data to update the received global model. Because the resources and local data distribution of these devices are different, the server needs to assign the locally updated number of iterations for the selected device according to the resource information of the devices, to make the global models be converged more quickly. Finally, the server aggregates updates of all the selected devices of the current task to obtain a new global model, and thus a round of training is completed so far. In this process, the plurality of tasks are executed in parallel without waiting for each other, and each task repeats all the above steps except for the initialization step before the global models reach expected performance or converge.

In some embodiments of the present disclosure, the reinforcement learning model may be pre-trained, and after the model is well trained, the model will not be adjusted. This mode may be called a static scheduling mode. Alternatively, training can be performed while scheduling. In some embodiments, after the reinforcement learning model is trained, and the reinforcement learning model is used to schedule the devices, the reinforcement learning model can be updated. This mode may be called a dynamic scheduling mode.

In some example embodiments, after determining the target terminal devices corresponding to the tasks, it may further include:
the characteristic information of all the tasks, the resource information of the plurality of terminal devices and a device set composed of the plurality of terminal devices are taken as an environmental state of the reinforcement learning model, and the reinforcement learning model is updated based on the reward function; and
in response to the condition that the global models do not meet the preset condition, S1 is returned to continue to execute S1, S2, S31 and S32, and the determining the target terminal devices corresponding to the tasks by utilizing the resource information, may include:
   the resource information is input into the updated reinforcement learning model, and the target terminal devices corresponding to the tasks are obtained through the updated reinforcement learning model.

Even if the dynamic scheduling model is used, specifically, after the reinforcement learning model is used to schedule the devices in one iteration process of the tasks, that is, after the terminal devices corresponding to the tasks are determined, the reinforcement learning model may continue to be trained, which can also be understood as updating the reinforcement learning model. The specific updating process is similar to the above process of training the reinforcement learning model. The difference lies in that the environmental state used in the process of updating the reinforcement learning model in the scheduling process is the characteristic information of a plurality of to-be-trained tasks and the resource information of the plurality of terminal devices in the federated learning system, and these terminal devices in the federated learning system are scheduled.

In this way, the reinforcement learning model may be continuously updated based on the information of the current task to be completed and the resource information of the terminal device currently used for completing the task, which can improve the performance of the model.

All the terminal devices have the local data used for training the global models corresponding to all the tasks. If the devices with faster training are excessively selected, although this can speed up the training speed of certain round, it will make training of the global models concentrated on a small part of devices, which will eventually lead to a decrease in the convergence precision of the task. However, the ultimate objective of the embodiment of the present disclosure is to make all the federated learning tasks converge as soon as possible, while ensuring the accuracy of the model. Therefore, device scheduling is performed on the premise of ensuring the fairness of device participation as much as possible. First, in order to ensure the fairness of device participation as much as possible, to prevent some edge devices from participating in training excessively and to avoid selecting faster devices in the scheduling process, a hyperparameter Nₘ is introduced for each task. For any task, the participation frequency of the same device does not exceed Nₘ, which will improve the convergence speed of each task under the premise of ensuring the precision of the task.

In some example embodiments, the obtaining the resource information of the plurality of terminal devices, may include:
participation frequencies of all the terminal devices participating in training of the tasks are determined; the terminal devices of which the participation frequencies are smaller than a preset participation frequency threshold are taken as available terminal devices corresponding to the tasks; and resource information of the available terminal devices is obtained.

The participation frequency may be understood as the number of times of participating in the training of the global model corresponding to the task for one task. The terminal devices may set a parameter of parameter frequency, and after receiving the global models sent by the server, utilizing the local data to obtain the model parameters of the global models, and uploading the model parameters to the server, the parameter is increased by 1.

In the process of scheduling the devices for the tasks, if the participation frequency of a terminal device participating in the task is greater than or equal to the participation frequency threshold value, it is not considered to schedule the terminal device for the task again, only if the participation frequency is less than the preset participation frequency threshold value, the terminal device is provided to the server for scheduling as a candidate terminal device.

In this way, the convergence speed can be improved based on improving the training precision, that is, the task completion time is reduced, and the devices are reasonably scheduled.

For the static scheduling mode, some embodiments of the present disclosure provides a federated learning mode. Specifically, the following steps may be included:

Step B1, an unavailable device set Hₘ of the task m and the frequency F^{k}ₘ of the device participating in the training of the task m are initialized.

Step B2, if the number of devices in the unavailable device set Hₘ exceeds

$$( 1 - \frac{1}{M} )$$

of the total device number |κ|, Hₘ is set to be null, and the frequency F^{k}ₘ is subjected to zero clearing; otherwise, move on to step B3.

In a process of determining the unavailable device set, a limit parameter Nₘ of the participation frequency can be introduced, that is, the participation frequency threshold value.

If F^{k}ₘ is greater than Nm, as for the task m, the terminal device may be understood as a terminal device in the unavailable device set.

Step B3, the devices in the unavailable device set Hₘ will be removed from the available device set Θₘ^{r}.

Step B4, the above reinforcement learning model is called with the available device set Θₘ^{r} of the task m and a task number m as parameters to schedule a device set sₘ^{r} required for the current training.

At this time, it can be understood as a non-training mode, that is, the reinforcement learning model will not be updated after the training is completed, and the reinforcement learning model is not adjusted during the scheduling process any more.

Step B5, the frequency F^{k}ₘ of the device participating in the training of the task m in the device set sₘ^{r} are counted.

Step B6, the scheduling device set sₘ^{r} of the task m is returned.

In the static scheduling mode, the pre-trained reinforcement learning model is directly loaded into the federated learning environment to schedule the device required for the current round of training for each task, and the model is not trained any more in the future. Furthermore, for the fairness of device participation, to prevent part of devices from excessively participating to cause overfitting of the task model and to improve the convergence speed of the task model, a limit Nₘ for the device participation frequency of each task may be introduced.

For the dynamic scheduling mode, some embodiments of the present disclosure provides a federated learning mode. Specifically, the following steps may be included:

Step C1, an unavailable device set Hₘ of the task m and the frequency F^{k}ₘ of the device participating in the training of the task m are initialized.

Step C2, if the number of devices in the unavailable device set Hₘ exceeds

$$( 1 - \frac{1}{M} )$$

of the total device number |κ|, Hₘ is set to be null, and the frequency F^{k}ₘ is subjected to zero clearing; otherwise, move on to step C3.

Step C3, the devices in the unavailable device set Hₘ will be removed from the available device set Θₘ^{r}.

Step C4, the above reinforcement learning model is called with the available device set Θₘ^{r} of the task m, the task number m and a training mode train=False as parameters to schedule a device set sₘ^{r} required for the current training.

Step C5, the frequency F^{k}ₘ of the device participating in the training of the task m in the device set sₘ^{r} are counted.

Step C6, the above reinforcement learning model is updated with the available device set Θₘ^{r} of the task m and a training mode train=True as parameters.

At this time, it can be understood as a training mode. After the above reinforcement learning model is called to schedule the device, the reinforcement learning model continues to be updated.

Model features of all the tasks of federated learning, an available device Θₘ^{r} of a current task m in an environment, a task number m, a size of task training data and the like are served as the environmental state to be input into the LSTM, then the probability of the current task on each available device is obtained, and finally, a part of devices with the largest probability is selected to serve as a scheduling solution sₘ of the current task. Then the environmental state is updated to compute a reward r of the selected scheduling solution according to the above reward function, then r is fed back to the reinforcement learning model for learning, so that the higher reward is obtained next time, and the above processes are repeated all the time until the number of iterations is reached. After it is end, the updated deep learning scheduling network is saved to cover the old reinforcement learning model, so that it is the latest scheduling network during scheduling again, that is, the latest reinforcement learning model.

In some embodiments, the process of updating the reinforcement learning model is similar to the above process of training the reinforcement learning model, which has been described in detail in the above embodiment, and will not be repeated here.

Step C7, the scheduling device set sₘ^{r} of the task m is returned.

In the dynamic scheduling mode, the pre-trained deep reinforcement learning network may be loaded into the federated learning environment, and then the device required for training is scheduled for each task. Furthermore, after one scheduling is completed, the neural network continues to learn, that is, it continues to learn while scheduling. This algorithm can further optimize the scheduling algorithm, that is, optimize the reinforcement learning model for scheduling the device. A deep reinforcement learning scheduling network may be provided to schedule the device and update a function of the neural network. After the device is scheduled, the current scheduling network will be further trained again, which can make the next scheduling be wiser.

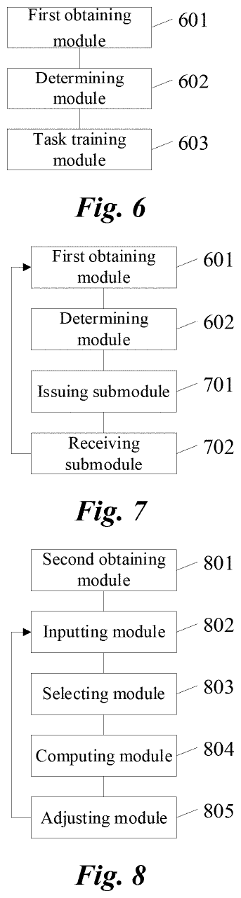

Corresponding to the federated learning method provided by the above embodiment, an embodiment of the present disclosure further provides a federated learning apparatus, applied to a server in a federated learning system, the federated learning system includes the server and a plurality of terminal devices, the federated learning system is used for completing a plurality of tasks, and as shown in FIG. 6, the apparatus may include:
a first obtaining module 601, configured to obtain resource information of the plurality of terminal devices;
a determining module 602, configured to determine target terminal devices corresponding to the tasks by utilizing the resource information; and
a task training module 603, configured to train global models corresponding to the tasks through the target terminal devices until the global models meets a preset condition.

For example, the task training module 603, as shown in FIG. 7, may include:
an issuing submodule 701, configured to issue the global models corresponding to the tasks to the target terminal devices corresponding to the tasks, so as to enable all the target terminal devices to train the global models to obtain model parameters; and
a receiving submodule 702, configured to receive the model parameters returned by all the target terminal devices, and aggregate the model parameters returned by all the target terminal devices to obtain updated global models; and in response to the condition that the global models do not meet the preset condition, return to the first obtaining module 601, and call the first obtaining module 601, the determining module 602, the issuing submodule 701 and the receiving submodule 702 until the global models meet the preset condition.

For example, the determining module 602 is specifically configured to input the resource information into a pre-trained reinforcement learning model, and obtain the target terminal devices corresponding to the tasks through the reinforcement learning model; wherein, the reinforcement learning model is obtained by taking a sample terminal device set capable of being used by a plurality of sample tasks, resource information of all sample terminal devices and characteristic information of the sample tasks as an environmental state and learning based on a reward function, and the reward function is determined based on the time spent by the sample terminal devices in completing the sample tasks and distribution of data required for completing the sample tasks in the sample terminal devices.

In some embodiments, as shown in FIG. 8, the apparatus further includes:
a second obtaining module 801, configured to obtain the characteristic information of the sample tasks; and obtain the sample terminal device set capable of being used by the sample tasks, and the resource information of all the sample terminal devices in the sample terminal device set;
an inputting module 802, configured to input the sample terminal device set, the resource information of all the sample terminal devices and the characteristic information of the sample tasks into a model;
a selecting module 803, configured to select scheduling devices corresponding to the sample tasks from the sample terminal device set through the model based on the resource information of all the sample terminal devices and the characteristic information of the sample tasks;
a computing module 804, configured to execute the sample tasks by utilizing the scheduling devices, and compute reward values corresponding to execution of the sample tasks by the scheduling devices through the reward function; and
an adjusting module 805, configured to adjust model parameters corresponding to the model based on the reward values to obtain an updated model; returning to the inputting module 802 under the condition that the updated model does not meet an iteration ending condition, replacing the above model with the updated model, and repeatedly calling the inputting module 802, the selecting module 803, the computing module 804 and the adjusting module 805 until the updated model meets the iteration ending condition to obtain a trained reinforcement learning model.

In some embodiments, the selecting module 803 is specifically configured to obtain probabilities that the sample tasks correspond to all the sample terminal devices respectively through the model based on the resource information of all the sample terminal devices and the characteristic information of the sample tasks; sort all the sample terminal devices according to the probabilities; and select a preset number of sample terminal devices to serve as the scheduling devices corresponding to the sample tasks based on a sorting result.

In some embodiments, the first obtaining module 601 is specifically configured to determine participation frequencies of all the terminal devices participating in training of the tasks; take the terminal devices of which the participation frequencies are smaller than a preset participation frequency threshold as available terminal devices corresponding to the tasks; and obtain resource information of the available terminal devices.

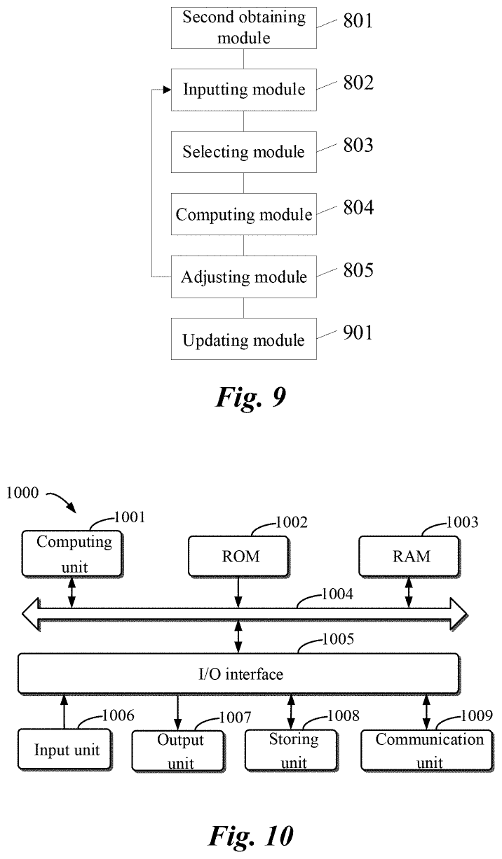

In some embodiments, as shown in FIG. 9, the apparatus further includes:
an updating module 901, configured to take the characteristic information of all the tasks, the resource information of the plurality of terminal devices and a device set composed of the plurality of terminal devices as an environmental state of the reinforcement learning model, and update the reinforcement learning model based on the reward function; and
the determining module 602, specifically configured to input the resource information into the updated reinforcement learning model, and obtain the target terminal devices corresponding to the tasks through the updated reinforcement learning model.

In some embodiments, the issuing submodule 701 is further configured to issue the number of iterations to all the target terminal devices in response to issuing the global models corresponding to the tasks to the target terminal devices corresponding to the tasks, so as to enable the process of training the global models by all the target terminal devices to be iterated for the number of iterations, wherein, the number of iterations is determined by the server based on the resource information of the terminal devices.

According to embodiments of the present disclosure, the present disclosure further provides an electronic device, a readable storage medium and a computer program product.

FIG. 10 shows a schematic block diagram of an example electronic device 1000 capable of being used for implementing the embodiments of the present disclosure. The electronic device aims to express various forms of digital computers, such as a laptop computer, a desk computer, a work bench, a personal digital assistant, a server, a blade server, a mainframe computer and other proper computers. The electronic device may further express various forms of mobile apparatuses, such as a personal digital assistant, a cellular phone, a smart phone, a wearable device and other similar computing apparatuses. Parts shown herein, their connection and relations, and their functions only serve as an example, and are not intended to limit implementation of the present disclosure described and/or required herein.

As shown in FIG. 10, a device 1000 includes a computing unit 1001, which may execute various motions and processing according to a computer program stored in a read-only memory (ROM) 1002 or a computer program loaded from a storing unit 1008 to a random access memory (RAM) 1003. In RAM 1003, various programs and data required by operation of the device 1000 may further be stored. The computing unit 1001, ROM 1002 and RAM 1003 are connected with one another through a bus 1004. An input/output (I/O) interface 1005 is also connected to the bus 1004.

A plurality of parts in the device 1000 are connected to the I/O interface 1005, including: an input unit 1006 such as a keyboard and a mouse; an output unit 1007, such as various types of displays and speakers; the storing unit 1008, such as a magnetic disc and an optical disc; and a communication unit 1009, such as a network card, a modem, and a wireless communication transceiver. The communication unit 1009 allows the device 1000 to exchange information/data with other devices through a computer network such as Internet and/or various telecommunication networks.

The computing unit 1001 may be various general and/or dedicated processing components with processing and computing abilities. Some examples of the computing unit 1001 include but not limited to a central processing unit (CPU), a graphic processing unit (GPU), various dedicated artificial intelligence (AI) computing chips, various computing units running a machine learning model algorithm, a digital signal processor (DSP), and any proper processor, controller, microcontroller, etc. The computing unit 1001 executes all methods and processing described above, such as the federated learning method. For example, in some embodiments, the federated learning method may be implemented as a computer software program, which is tangibly contained in a machine readable medium, such as the storing unit 1008. In some embodiments, part of all of computer programs may be loaded into and/or mounted on the device 1000 via the ROM 1002 and/or the communication unit 1009. When the computer program is loaded to the RAM 1003 and executed by the computing unit 1001, one or more steps of the federated learning method described above may be executed. Alternatively, in other embodiments, the computing unit 1001 may be configured to execute the federated learning method through any other proper modes (for example, by means of firmware).

Various implementations of the systems and technologies described above in this paper may be implemented in a digital electronic circuit system, an integrated circuit system, a field programmable gate array (FPGA), an application specific integrated circuit (ASIC), an application specific standard part (ASSP), a system on chip (SOC), a load programmable logic device (CPLD), computer hardware, firmware, software and/or their combinations. These various implementations may include: being implemented in one or more computer programs, wherein the one or more computer programs may be executed and/or interpreted on a programmable system including at least one programmable processor, and the programmable processor may be a special-purpose or general-purpose programmable processor, and may receive data and instructions from a storage system, at least one input apparatus, and at least one output apparatus, and transmit the data and the instructions to the storage system, the at least one input apparatus, and the at least one output apparatus.

Program codes for implementing the methods of the present disclosure may be written in any combination of one or more programming languages. These program codes may be provided to processors or controllers of a general-purpose computer, a special-purpose computer or other programmable data processing apparatuses, so that when executed by the processors or controllers, the program codes enable the functions/operations specified in the flow diagrams and/or block diagrams to be implemented. The program codes may be executed completely on a machine, partially on the machine, partially on the machine and partially on a remote machine as a separate software package, or completely on the remote machine or server.

In the context of the present disclosure, a machine readable medium may be a tangible medium that may contain or store a program for use by or in connection with an instruction execution system, apparatus or device. The machine readable medium may be a machine readable signal medium or a machine readable storage medium. The machine readable medium may include but not limited to an electronic, magnetic, optical, electromagnetic, infrared, or semiconductor system, apparatus or device, or any suitable combination of the above contents. More specific examples of the machine readable storage medium will include electrical connections based on one or more lines, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

In order to provide interactions with users, the systems and techniques described herein may be implemented on a computer, and the computer has: a display apparatus for displaying information to the users (e.g., a CRT (cathode ray tube) or LCD (liquid crystal display) monitor); and a keyboard and a pointing device (e.g., a mouse or trackball), through which the users may provide input to the computer. Other types of apparatuses may further be used to provide interactions with users; for example, feedback provided to the users may be any form of sensory feedback (e.g., visual feedback, auditory feedback, or tactile feedback); an input from the users may be received in any form (including acoustic input, voice input or tactile input).

The systems and techniques described herein may be implemented in a computing system including background components (e.g., as a data server), or a computing system including middleware components (e.g., an application server) or a computing system including front-end components (e.g., a user computer with a graphical user interface or a web browser through which a user may interact with the implementations of the systems and technologies described herein), or a computing system including any combination of such background components, middleware components, or front-end components. The components of the system may be interconnected by digital data communication (e.g., a communication network) in any form or medium. Examples of the communication network include: a local area network (LAN), a wide area network (WAN) and the Internet.

A computer system may include a client and a server. The client and the server are generally away from each other and are usually interacted through a communication network. A relationship of the client and the server is generated through the computer programs run on a corresponding computer and mutually having a client-server relationship. The server may be a cloud server or a server of a distributed system, or a server in combination with a blockchain.

It should be understood that various forms of flows shown above may be used to reorder, increase or delete the steps. For example, all the steps recorded in the present disclosure may be executed in parallel, may also be executed sequentially or in different sequences, as long as the expected result of the technical solution disclosed by the present disclosure may be implemented, which is not limited herein.

The above specific implementation does not constitute the limitation to the protection scope of the present disclosure. It should be understood by those skilled in the art that various modifications, combinations, sub-combinations and substitutions may be made according to design requirements and other factors. Any modification, equivalent substitution, improvement and the like made within the spirit and scope of the present disclosure shall all be contained in the protection scope of the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method comprising:
executing, for each task in a federated learning system, a first training process comprising:
obtaining resource information of a plurality of terminal devices of the federated learning system;
determining one or more target terminal devices corresponding to the task based on the resource information; and
training a global model corresponding to the task by the target terminal devices until the global model meets a threshold.

2. The method according to claim 1, wherein the training the global model corresponding to the task by the target terminal devices until the global model meets the threshold comprising:
issuing the global model corresponding to the task to target terminal devices corresponding to the task;
enabling each target terminal device of the target terminal devices to train the global model to obtain model parameters;
receiving the model parameters returned by the each target terminal device;
aggregating the model parameters returned by the each target terminal device to obtain updated global model; and
in response to the global model not meeting the threshold, continuing to execute the first training process until the global model meets the threshold.

3. The method according to claim 1, wherein the determining one or more target terminal devices corresponding to the task based on the resource information comprising:
inputting the resource information into a pre-trained reinforcement learning model; and
obtaining the target terminal devices corresponding to the task by the reinforcement learning model,
wherein, the reinforcement learning model is obtained by taking a sample terminal device set capable of being used by a plurality of sample tasks, resource information of all sample terminal devices and characteristic information of each sample task of the plurality of sample tasks as an environmental state and learning based on a reward function, and the reward function is determined based on a time spent by the sample terminal devices in completing the each sample task and distribution of data required for completing the each sample task in the sample terminal devices.

4. The method according to claim 3, further comprising:
obtaining the characteristic information of the sample tasks;
executing, for each sample task of the plurality of sample tasks, a second training process comprising:
obtaining a sample terminal device set capable of being used by the sample task, and the resource information of all the sample terminal devices in the sample terminal device set;
inputting the sample terminal device set, the resource information of all the sample terminal devices and the characteristic information of the sample task into the reinforcement learning model;
selecting scheduling devices corresponding to the sample task from the sample terminal device set by the reinforcement learning model based on the resource information of all the sample terminal devices and the characteristic information of the sample task;
executing the sample task by the scheduling devices;
computing reward values corresponding to execution of the sample task by the scheduling devices through the reward function; and
adjusting model parameters corresponding to the reinforcement learning model based on the reward values to obtain an updated model; and
in response to the updated model not meeting an iteration ending condition, replacing the above model with the updated model, and repeatedly executing the second training process until the updated model meets the iteration ending condition to obtain a trained reinforcement learning model.

5. The method according to claim 4, wherein the selecting scheduling devices corresponding to the sample task from the sample terminal device set by the reinforcement learning model based on the resource information of all the sample terminal devices and the characteristic information of the sample tasks comprising:
obtaining probabilities that the sample task correspond to all the sample terminal devices respectively by the reinforcement learning model based on the resource information of all the sample terminal devices and the characteristic information of the sample task;
sorting all the sample terminal devices according to the probabilities; and
selecting a preset number of sample terminal devices as the scheduling devices corresponding to the sample task based on a sorting result.

6. The method according to claim 1, wherein the obtaining resource information of the plurality of terminal devices comprising:
determining participation frequencies of all the terminal devices participating in training of the task;
taking terminal devices of which the participation frequencies are smaller than a preset participation frequency threshold as available terminal devices corresponding to the task; and
obtaining resource information of the available terminal devices.

7. The method according to claim 4, wherein after the determining the target terminal devices corresponding to the each task, further comprising:
taking the characteristic information of all the tasks, the resource information of the plurality of terminal devices and a device set composed of the plurality of terminal devices as an environmental state of the reinforcement learning model, and updating the reinforcement learning model based on the reward function; and
the determining one or more target terminal devices corresponding to the task based on the resource information comprising:
inputting the resource information into the updated reinforcement learning model, and obtaining one or more target terminal devices corresponding to the task by the updated reinforcement learning model.

8. The method according to claim 2, further comprising:
issuing the number of iterations to all the target terminal devices in response to issuing the global model corresponding to the task to the target terminal devices corresponding to the task; and
enabling the global model be iterated for the number of iterations during the process of training the global model by all the target terminal devices, wherein, the number of iterations is determined by a server of the federated learning system based on the resource information of the terminal devices.

9. A computing device, comprising:
one or more processors; and
a memory storing one or more programs configured to be executed by the one or more processors, the one or more programs comprising instructions for performing operations comprising:
executing, for each task in a federated learning system, a first training process comprising:
obtaining resource information of a plurality of terminal devices of the federated learning system;
determining one or more target terminal devices corresponding to the task based on the resource information; and
training a global model corresponding to the task by the target terminal devices until the global model meets a threshold.

10. The computing device according to claim 9, wherein the training the global model corresponding to the task by the target terminal devices until the global model meets the threshold comprising:
issuing the global model corresponding to the task to target terminal devices corresponding to the task;
enabling each target terminal device of the target terminal devices to train the global model to obtain model parameters;
receiving the model parameters returned by the each target terminal device; and
aggregating the model parameters returned by the each target terminal device to obtain updated global model; and
in response to the global model not meeting the threshold, continuing to execute the first training process until the global model meets the threshold.

11. The computing device according to claim 9, wherein the determining one or more target terminal devices corresponding to the task based on the resource information comprising:
inputting the resource information into a pre-trained reinforcement learning model; and
obtaining the target terminal devices corresponding to the task by the reinforcement learning model,
wherein, the reinforcement learning model is obtained by taking a sample terminal device set capable of being used by a plurality of sample tasks, resource information of all sample terminal devices and characteristic information of each sample task of the plurality of sample tasks as an environmental state and learning based on a reward function, and the reward function is determined based on a time spent by the sample terminal devices in completing the each sample task and distribution of data required for completing the each sample task in the sample terminal devices.

12. The computing device according to claim 11, further comprising:
obtaining the characteristic information of the sample tasks;
executing, for each sample task of the plurality of sample tasks, a second training process comprising:
obtaining a sample terminal device set capable of being used by the sample task, and the resource information of all the sample terminal devices in the sample terminal device set;
inputting the sample terminal device set, the resource information of all the sample terminal devices and the characteristic information of the sample task into the reinforcement learning model;
selecting scheduling devices corresponding to the sample task from the sample terminal device set by the reinforcement learning model based on the resource information of all the sample terminal devices and the characteristic information of the sample task;
executing the sample task by the scheduling devices; and
computing reward values corresponding to execution of the sample task by the scheduling devices through the reward function;
adjusting model parameters corresponding to the reinforcement learning model based on the reward values to obtain an updated model; and
in response to the updated model not meeting an iteration ending condition, replacing the above model with the updated model, and repeatedly executing the second training process until the updated model meets the iteration ending condition to obtain a trained reinforcement learning model.

13. The computing device according to claim 12, wherein the selecting scheduling devices corresponding to the sample task from the sample terminal device set by the reinforcement learning model based on the resource information of all the sample terminal devices and the characteristic information of the sample tasks comprising:
obtaining probabilities that the sample task correspond to all the sample terminal devices respectively by reinforcement learning the model based on the resource information of all the sample terminal devices and the characteristic information of the sample task;
sorting all the sample terminal devices according to the probabilities; and
selecting a preset number of sample terminal devices as the scheduling devices corresponding to the sample task based on a sorting result.

14. The computing device according to claim 9, wherein the obtaining resource information of the plurality of terminal devices comprising:
determining participation frequencies of all the terminal devices participating in training of the task;
taking terminal devices of which the participation frequencies are smaller than a preset participation frequency threshold as available terminal devices corresponding to the task; and
obtaining resource information of the available terminal devices.

15. The computing device according to claim 12, wherein after the determining the target terminal devices corresponding to the each task, further comprising:
taking the characteristic information of all the tasks, the resource information of the plurality of terminal devices and a device set composed of the plurality of terminal devices as an environmental state of the reinforcement learning model, and updating the reinforcement learning model based on the reward function; and
the determining one or more target terminal devices corresponding to the task based on the resource information comprising:
inputting the resource information into the updated reinforcement learning model, and obtaining one or more target terminal devices corresponding to the task by the updated reinforcement learning model.

16. The computing device according to claim 10, further comprising:
issuing the number of iterations to all the target terminal devices in response to issuing the global model corresponding to the task to the target terminal devices corresponding to the task; and
enabling the global model be iterated for the number of iterations during the process of training the global model by all the target terminal devices, wherein, the number of iterations is determined by a server of the federated learning system based on the resource information of the terminal devices.

17. A non-transitory computer readable storage medium, storing one or more programs comprising instructions that, when executed by one or more processors of a computing device, cause the computing device to perform operations comprising:
executing, for each task in a federated learning system, a first training process comprising:
obtaining resource information of a plurality of terminal devices of the federated learning system;
determining one or more target terminal devices corresponding to the task based on the resource information; and
training a global model corresponding to the task by the target terminal devices until the global model meets a threshold.

18. The computer readable storage medium of claim 17, wherein the training the global model corresponding to the task by the target terminal devices until the global model meets the threshold comprising:
issuing the global model corresponding to the task to target terminal devices corresponding to the task;
enabling each target terminal device of the target terminal devices to train the global model to obtain model parameters;
receiving the model parameters returned by the each target terminal device;
aggregating the model parameters returned by the each target terminal device to obtain updated global model; and
in response to the global model not meeting the threshold, continuing to execute the first training process until the global model meet the threshold.

19. The computer readable storage medium of claim 17, wherein the determining one or more target terminal devices corresponding to the task based on the resource information comprising:
inputting the resource information into a pre-trained reinforcement learning model; and
obtaining the target terminal devices corresponding to the task by the reinforcement learning model,
wherein, the reinforcement learning model is obtained by taking a sample terminal device set capable of being used by a plurality of sample tasks, resource information of all sample terminal devices and characteristic information of each sample task of the plurality of sample tasks as an environmental state and learning based on a reward function, and the reward function is determined based on a time spent by the sample terminal devices in completing the each sample task and distribution of data required for completing the each sample task in the sample terminal devices.

20. The computer readable storage medium of claim 19, further comprising:
obtaining the characteristic information of the sample tasks;
executing, for each sample task of the plurality of sample tasks, a second training process comprising:
obtaining a sample terminal device set capable of being used by the sample task, and the resource information of all the sample terminal devices in the sample terminal device set;
inputting the sample terminal device set, the resource information of all the sample terminal devices and the characteristic information of the sample task into the reinforcement learning model;
selecting scheduling devices corresponding to the sample task from the sample terminal device set by the reinforcement learning model based on the resource information of all the sample terminal devices and the characteristic information of the sample task;
executing the sample task by the scheduling devices; and
computing reward values corresponding to execution of the sample task by the scheduling devices through the reward function;
adjusting model parameters corresponding to the reinforcement learning model based on the reward values to obtain an updated model; and
in response to the updated model not meeting an iteration ending condition, replacing the above model with the updated model, and repeatedly executing the second training process until the updated model meets the iteration ending condition to obtain a trained reinforcement learning model.
